(19) United States
(12) Patent Application Publication
(10) Pub. No.: US 2010/0265513 A1
(43) Pub. Date: Oct. 21, 2010

(54) Solid-state multioscillator ring laser gyro using a <100>-cut crystalline gain medium

(75) Inventors: Sylvain Schwartz, Saint-Remy Les Chevreuse (FR); Gilles Feugnet, Palaiseau (FR); Jean-Paul Pocholle, La Norville (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, NEUILLY-SUR-SEINE (FR)

(21) Appl. No.: 12/808,582

(22) PCT Filed: Dec. 1, 2008
(86) PCT No.: PCT/EP08/66510

§ 371 Date: Jun. 16, 2010

(30) Foreign Application Priority Data
Dec. 18, 2007 (FR) 0708843

(51) Int. Cl. G01C 19/66

(52) U.S. Cl. 356/467

(57) ABSTRACT

A multioscillator ring laser gyro includes an optical ring cavity, a solid-state amplifying medium and a measurement device arranged in such a way that a first linearly polarized propagation mode and a second linearly polarized propagation mode, perpendicular to the first mode, propagate in a first direction in the cavity and in such a way that a third linearly polarized propagation mode parallel to the first mode and a fourth linearly polarized propagation mode parallel to the second mode propagate in the opposite direction. The amplifying medium is a crystal of cubic symmetry having an entry face and an exit face, the crystal being cut so that said faces are approximately perpendicular to the <100> crystallographic direction, the various modes propagating in directions approximately perpendicular to said faces.

The field of the invention is that of ring laser gyros, these being rotation sensors used for inertial navigation. Although most ring laser gyros currently available on the market use a helium/neon gas mixture as gain medium, the possibility of substituting this gas mixture with a solid-state medium, for example a laser-diode-pumped Nd—YAG (neodymium-doped yttrium aluminum garnet) crystal has recently been demonstrated. Such a device is called a solid-state ring laser gyro.

One of the key points determining the inertial performance quality of a ring laser gyro is the way in which the so-called “lock-in zone” problem is circumvented, i.e. the problem of mode synchronization at low rotation velocities, which renders measurement over an entire velocity range impossible. In the usual version of a helium/neon ring laser gyro, this problem is solved by mechanically activating the cavity, i.e. by giving said cavity a reciprocating movement about its axis, thereby enabling the cavity to be maintained as often as possible outside the lock-in zone.

This technique may be transposed to the solid-state ring laser gyro case, taking into account the specific problems associated with the homogeneous character of the gain medium, by coupling the amplifying medium to an electromechanical for making said amplifying medium undergo a periodic translational movement along an axis approximately parallel to the propagation direction of the optical modes that propagate in the cavity. There is another possible way of circumventing the lock-in zone problem, without using a mechanical movement, which involves introducing a magnetooptic frequency bias so as to simulate a rotation enabling the ring laser gyro to be placed in a linear operating zone. The inertial performance quality of the devices produced according to this principle depends directly on the way in which the initially introduced frequency bias is subtracted from the measurement signal. As has already been pointed out in the past within the context of gas ring laser gyro studies, simple subtraction of the average value of this bias can only result in a ring laser gyro of low or moderate performance because of the fluctuations and a drift in the bias that impinge directly on the signal. A method for retaining the benefit of a magnetooptic bias, while still obviating the fluctuations and drift thereof, does exist, in which the operating principle, known by the name “multioscillator ring laser gyro” or “4-mode ring laser gyro”, consists in making two pairs of counter-propagating modes oscillating in orthogonal polarization states coexist in the cavity and in ensuring that the two pairs are sensitive to the same magnetooptic bias but with opposite signs. The measurement signal, formed by the difference between the beat frequencies coming from the two pairs of counter-propagating modes, is thus independent of the value of the bias, and therefore in particular insensitive to the fluctuations and drift thereof. This type of device has been extensively described and studied in its helium/neon version. For example, the U.S. Pat. No. 3,741,657 (1973) of K. Andring a, entitled “Laser gyroscope” or the publication by W. Chow, J. Hambenne, T. Hutchings, V. Sanders, M. Sargent III and M. Scully, entitled “Multioscillator Laser Gyros”, IEEE Journal of Quantum Electronics 16 (9), 918 (1980) may be mentioned. The company Northrop Grumman (previously Litton) currently markets a high-performance laser gyro based on this so-called “zero-lock” principle.

Transposition of the Litton zero-lock technologies to a solid-state ring laser gyro is possible and enables the lock-in zone problem to be solved. However, solid-state lasers have other problems. The condition for observing the beat, and therefore for operating the ring laser gyro, is the stability and relative equality of the intensities emitted in the two directions. This is not a priori an easy thing to achieve because of the phenomenon of mode competition, which means that one of the two counter-propagating modes may have a tendency to monopolize the available gain, to the detriment of the other mode. The problem of bidirectional emission instability for a solid-state ring laser may be solved by installing a feedback loop intended to control the difference between the intensities of the two counter-propagating modes around a fixed value. This loop acts on the laser either by making its losses dependent on the propagation direction, for example by means of a reciprocal-rotation element, a nonreciprocal rotation element and a polarizing element (patent FR 03/03645), or by making its gain dependent on the propagation direction, for example by means of a reciprocal-rotation element, a nonreciprocal-rotation element and a polarized-emission crystal (patent FR 03/14598). Once controlled, the laser emits two counter-propagating beams, the intensities of which are stable and can be used as a laser gyro.

However, the abovementioned techniques do not solve the problem of competition between the orthogonal modes. Experimentally, this insufficiency limits in practice the stability of the beat obtained to a few tens of seconds on the solid-state multioscillator ring laser gyro, as described in the PhD thesis by S. Schwartz entitled “Gyrolaser à état solide. Application des lasers à atomes àla gyrométrie” [Solid-state ring laser gyro. Application of atom lasers to gyrometry] published in 2006.

The laser gyro according to the invention has a particular gain medium enabling the competition between orthogonal modes to be reduced.

More precisely, one subject of the invention is a multioscillator ring laser gyro for measuring relative angular position or angular velocity along a defined rotation axis, comprising at least an optical ring cavity, a solid-state amplifying medium and a measurement device that are arranged in such a way that a first linearly polarized propagation mode and a second linearly polarized propagation mode, perpendicular to the first mode, are able to propagate in a first direction in the cavity and in such a way that a third linearly polarized propagation mode parallel to the first mode and a fourth linearly polarized propagation mode parallel to the second mode are able to propagate in the opposite direction in the cavity, characterized in that the amplifying medium is a crystal of cubic symmetry having an entry face and an exit face, the crystal being cut so that said faces are approximately perpendicular to the <100> crystallographic direction, the angles of incidence of the various modes on said faces being approximately perpendicular to said faces.

In a first possible embodiment, the ring laser gyro comprises, at least, a laser diode producing the population inversion of the amplifying medium, said diode emitting a light beam passing through the crystal, the beam being linearly polarized along a direction defined by the bisector of the angle made by the directions of the polarization states of the laser cavity eigenmodes.

In a second possible embodiment, the ring laser gyro comprises, at least, two laser diodes producing the population inversion of the amplifying medium, each emitting a light beam, each beam being linearly polarized along one of the intrinsic axes of the laser cavity, the polarization direction of the first beam being perpendicular to the polarization direction of the second beam.

Advantageously, the laser gyro includes a feedback device for controlling the intensity of the counter-propagating modes, comprising at least:
a first optical assembly consisting of a first optical rotator having a nonreciprocal effect and an optical element, said optical element being either an optical rotator having a reciprocal effect or a birefringent element, at least one of the effects or the birefringence being adjustable;
a second optical assembly consisting of a first spatial filtering device and a first optical polarization-splitting element;
a third optical assembly consisting of a second spatial filtering device and a second optical polarization-splitting element, the second optical assembly and the third optical assembly being placed on either side of the first optical assembly, the third optical assembly being placed symmetrically with respect to the second optical assembly;
   and the laser gyro also includes a device for eliminating the blind zone, comprising:
a fourth optical assembly consisting, in succession, of a first quarter-wave plate, a second optical rotator having a nonreciprocal effect and a second quarter-wave plate, the principal axes of which are perpendicular to those of the first quarter-wave plate, the principal axes of the first quarter-wave plate and of the second quarter-wave plate being inclined at about 45° to the linear polarization directions of the four propagation modes, the optical frequencies of the four modes all being different.

Finally, the invention also relates to a system for measuring angular velocities or relative angular positions along three different axes, which comprises three multioscillator ring laser gyros having one of the above features, the three ring laser gyros being oriented along different directions and mounted on a common mechanical structure.

The invention will be better understood and other advantages will become apparent on reading the following description given by way of nonlimiting example and in conjunction with the appended figures in which:

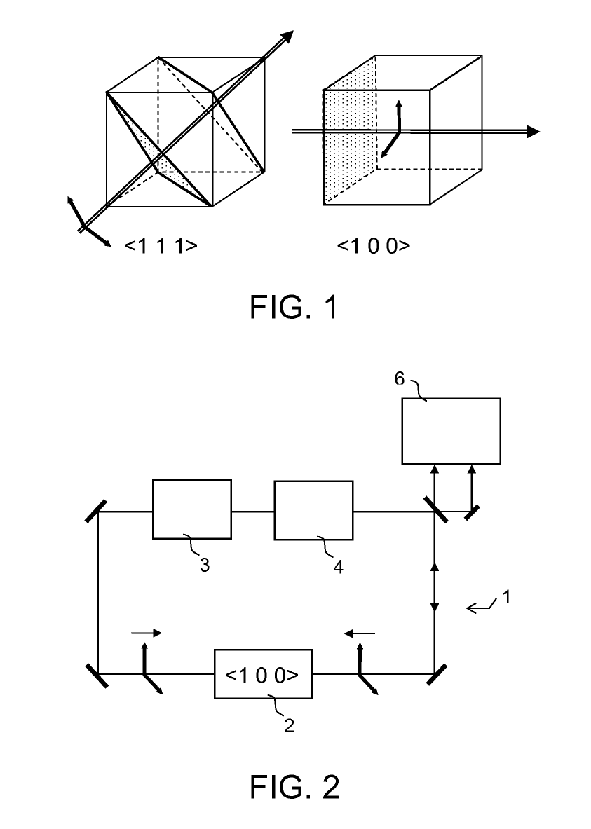

FIG. 1 represents various cuts of a cubic crystal;

FIG. 2 represents a block diagram of a multioscillator ring laser gyro according to the invention;

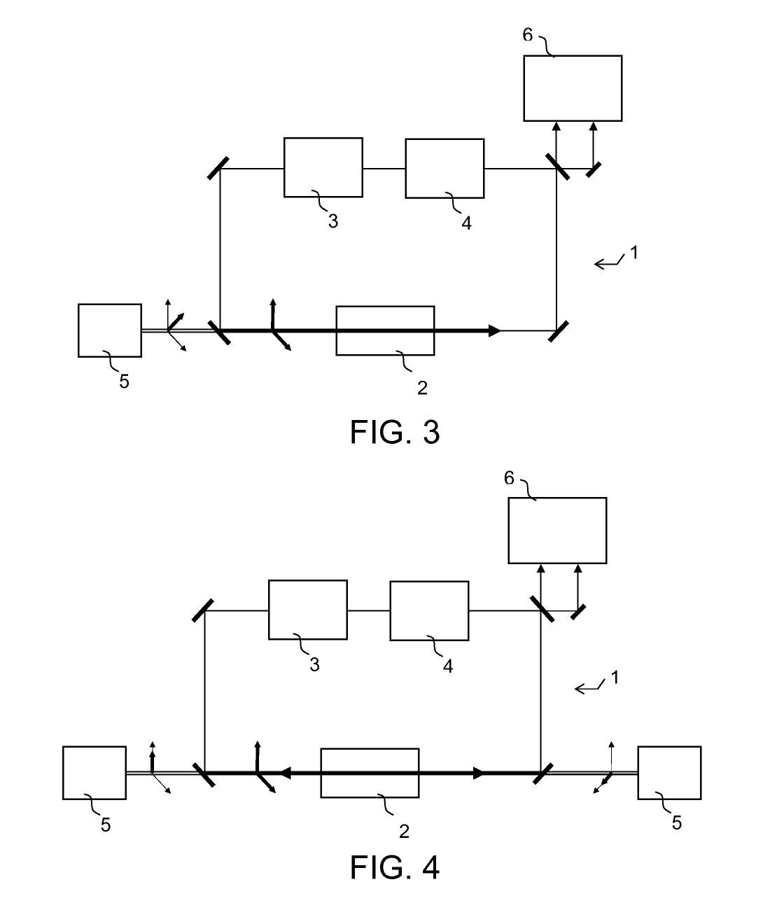

FIG. 3 represents a first optical pumping mode for an amplifier according to the invention;

FIG. 4 represents a second optical pumping mode for an amplifier according to the invention; and

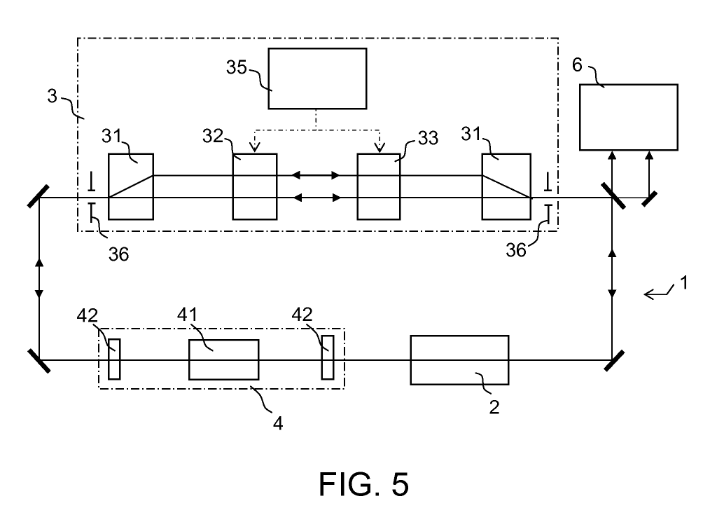

FIG. 5 represents a block diagram of a multioscillator ring laser gyro according to the invention comprising a feedback device for controlling the intensity of the counterpropagating modes and a second device, for eliminating the blind zone.

The fundamental principle of the laser gyro according to the invention is the correlation that exists, in a doped crystalline medium, between the orientations of the crystal axes on the one hand and the dipoles of the dopant ions on the other. This correlation has already been demonstrated, for different applications, in the case of saturable absorbent media. For example, the following publications may be mentioned on this subject: H. Eilers, K. Hoffman, W. Dennis, S. Jacobsen and W. Yen, Appl. Phys. Lett. 61 (25), 2958 (1992); and M. Brunel, O. Emile, M. Vallet, F. Bretenaker, A. Le Floch, L. Fulbert, J. Marty, B. Ferrand and E. Molva, Phys. Rev. A 60 (5), 4052 (1999).

By suitably orienting the axes of the crystal serving as gain medium relative to the polarization eigenstates of the laser, it is thus possible to ensure that each polarization eigenstate preferentially interacts with certain dipoles, this having the effect of reducing the coupling between the orothogonal eigenstates and therefore the phenomenon of intermodal competition.

In particular, when the gain medium used is cubic and cut in such a way that its faces are perpendicular to the <100> direction, a direction identified with respect to the axes of the crystal, using the Miller indices notation (the reader may refer on this subject to H. Miller, “A Treatise on Crystallography”, Oxford University (1839)), the coupling between the modes is significantly reduced compared with an ordinary cut made perpendicular to the <111> direction. Thus, if, in a laser cavity using a neodymium-ion-doped YAG crystal as gain medium, the force of the coupling between orthogonal modes on the one hand with a crystal cut along the <111> axis and on the other hand with a crystal cut along the <100> axis is measured, it is possible to obtain a coupling fifteen times smaller in the second case than in the first, thereby resulting in greater beat signal stability in a multioscillator solid-state ring laser gyro configuration. FIG. 1 shows two cuts of a cubic crystal, the drawing on the left representing a cut along the <111> axis and the drawing on the right representing a cut along the <100> axis. In these cuts, the cube represents the crystal lattice, the cut planes are represented by surfaces indicated by the dotted lines, and the laser beam propagation direction is indicated by a double arrow.

Consequently, the laser gyro according to the invention comprises a <100>-cut cubic single-crystal gain medium in order to increase measurement signal stability. It should be noted that the very great majority of commercially available single-crystal amplifying media are cut at <111>. Only a small number of specialized industrial manufacturers, such as the German company FEE, is capable of providing <100>-cut crystals.

The effect of a crystal cut at <100> compared with a crystal cut at <111> on the coupling between orthogonal eigenmodes of a laser may be illustrated by the following simplified model, which offers the advantage of presenting an intuitive view of the physical phenomenon involved. It is assumed that the axes of the dopant ion dipoles are oriented along the crystallographic axes of the gain medium, which is assumed to be cubic and defined by the pairwise orthogonal unit vectors eₓ, e_{y} and e_{z}. The dopant ions may be distributed along three families of dipoles, denoted by deₓ, de_{y} and de_{z}. The case in which the crystal is cut along the <111> axis is firstly considered. The wavevector k of a beam incident perpendicular to the faces of the crystal is then given by k=k(eₓ+e_{y}+e_{z})/\sqrt{3}. The two linear polarization eigenstates of the laser are denoted by Eᵤ and Eᵥ, these naturally satisfying the following equations:

Eᵤ·Eᵥ=0; Eᵤ·k=0 and Eᵥ·k=0.

It is then assumed (by reductio ad absurdum) that the family of dipoles are decoupled, that is to say if one mode interacts with one family then the other mode does not interact with it. Using our notations, this means that if a component along eₓ, e_{y} or e_{z} of Eᵤ is nonzero, then the corresponding component of Eᵥ must be zero. Since the vector Eᵤ is not zero, at least one of its components is nonzero. It is assumed, without loss of generality, that this is the component corresponding to the x axis, namely (Eᵤ·eₓ). This implies, according to the hypothesis of dipole family decoupling, that the component (Eᵥ·eₓ) is zero. The following relationship is therefore easily deduced from the equality Eᵥ·k=0:

Eᵥ·e_{y}=−Eᵥ·e_{z}≠0, since Eᵥ≠0.

This in turn makes it possible, using the equality Eᵤ·Eᵥ=0, to establish the following relationship:

Eᵤ·e_{y}=Eᵤ·e_{z}=0 according to the dipole decoupling hypothesis.

This then results, by considering the fact that Eᵤ·k=0, in the equality Eᵤeₓ=0, which is in contradiction with the starting hypothesis. The conclusion of this reductio ad absurdum reasoning is that it is not possible to completely decouple the two orthogonal modes when the crystal is cut along the <111> axis. Let us now consider the opposite case in which the crystal is cut along the <100> axis. The wavevector of the incident wave is then given by k=keₓ and the polarizations of the orthogonal eigenmodes take the form:

Eᵤ=Eᵤ₀(e_{y} cos α+e_{z} sin α) and Eᵥ=Eᵥ₀(−e_{y} sin α+e_{z} cos α),

in which the angle α depends on the orientation of the axes e_{y} and e_{z} relative to the polarizations of the intrinsic axes of the cavity. In particular when the crystal is oriented in such a way that α=0, the system is in a situation in which the mode Eᵤ interacts only with the dipole family de_{y}, whereas the mode Eᵥ interacts only with the dipole family de_{z}. There is therefore complete decoupling between two modes, something which is not possible with a crystal cut along the <111> axis. In conclusion, this simple model illustrates the benefit of a cut along the <100> axis for decoupling the orthogonal polarization modes in the gain medium.

FIG. 2 shows a block diagram of a multioscillator laser gyro according to the invention. It essentially comprises:
an optical ring cavity 1;
a solid-state amplifying medium 2;
a measurement device 6;
a feedback device 3 for controlling the intensity of the counter-propagating modes; and
a device 4 for eliminating the blind zone.

The assembly is arranged in such a way that a first linearly polarized propagation mode and a second linearly polarized propagation mode, perpendicular to the first mode, are able to propagate in a first direction in the cavity and in such a way that a third linearly polarized propagation mode parallel to the first mode and a fourth linearly polarized propagation mode parallel to the second mode are able to propagate in the opposite direction in the cavity. The polarization directions of these modes are represented in FIG. 2 by thick arrows.

The amplifying medium may be a neodymium-doped YAG crystal cut in such a way that the light entry and exit faces are perpendicular to the <100> or, equivalently, <010> or <001> crystallographic direction. The crystal is oriented so as to minimize the coupling between orthogonal modes.

The optical pumping may be provided for example by one or more laser diodes 5 emitting in the near infrared (typically at 808 nm). In a first embodiment illustrated in FIG. 3, a single pumping diode 5 may be used, this being linearly polarized along a direction defined by the bisector of the angle made by the directions of the polarization states of the laser cavity eigenmodes. In a second embodiment illustrated in FIG. 4, it is possible to use two laser diodes 5 emitting in opposite directions, each being linearly polarized along one of the intrinsic axes of the laser cavity. In these figures, the polarization directions of the beams emitted by the diodes are represented by thick arrows.

FIG. 5 shows a block diagram of a multioscillator ring laser gyro according to the invention that includes a feedback device for controlling the intensity of the counter-propagating modes and a device for eliminating the lock-in zone using a phase shifter.

The phase shifter system 4 may for example consist of a Faraday medium 41 (for example a TGG crystal placed in the magnetic field of a magnet) surrounded by two half-wave plates 42 at the laser emission wavelength. Whatever form it takes, though, the system 4 must have linear eigenstates between which it induces a nonreciprocal phase shift.

The intensity-stabilizing system 3 serves to circumvent the problem of competition between counter-propagating modes, thereby ensuring the existence and stability of the beat regime over the entire operating range of the multioscillator ring laser gyro. The system may for example consist of two polarization-splitting crystals 31 (uniaxial birefringent crystals cut at 45° to their optical axis, such as rutile or YVO4 crystals), which surround a Faraday rotator 32 (for example a TGG or YAG crystal placed in a solenoid) and a reciprocal rotator 33 (for example a natural optical rotator crystal, such as quartz). The intensities are then stabilized by a feedback control loop 35, which measures the intensities of the counter-propagating modes using two photodiodes and injects a current proportional to the difference in the measured intensities into the solenoid surrounding the Faraday rotator, as is described in French patent 04/02706 of S. Schwartz, G. Feugnet and J. P. Pocholle. It may prove necessary to use stops 36 (as shown in FIG. 5) in order for this type of device to operate correctly, even if they are not strictly essential.

The detection system 6 may be a detection system equivalent to those existing in normal multioscillator ring laser gyros. Additional information about this subject may be found in the U.S. Pat. No. 3,741,657 (1973) of K. Andring a entitled “Laser gyroscope” and in the publication by W. Chow, J. Hambenne, T. Hutchings, V. Sanders, M. Sargent III and M. Scully entitled “Multioscillator Laser Gyros”, IEEE Journal of Quantum Electronics 16 (9), 918 (1980). In general, the detection system comprises:
optical means for making, on the one hand, the first propagation mode interfere with the third propagation mode and, on the other hand, making the second propagation mode interfere with the fourth propagation mode;
optoelectronic means for determining, on the one hand, a first optical frequency difference between the first propagation mode and the third propagation mode and, on the other hand, a second frequency difference between the second propagation mode and the fourth propagation mode; and
electronic means for taking the difference between said first frequency difference and said second frequency difference.

1. A multioscillator ring laser gyro for measuring relative angular position or angular velocity along a defined rotation axis, comprising at least an optical ring cavity, a solid-state amplifying medium and a measurement device that are arranged in such a way that a first linearly polarized propagation mode and a second linearly polarized propagation mode, perpendicular to the first mode, are able to propagate in a first direction in the cavity and in such a way that a third linearly polarized propagation mode parallel to the first mode and a fourth linearly polarized propagation mode parallel to the second mode are able to propagate in the opposite direction in the cavity, wherein the amplifying medium is a crystal of cubic symmetry having an entry face and an exit face, the crystal being cut so that said faces are approximately perpendicular to the <100> crystallographic direction, the angles of incidence of the various modes on said faces being approximately perpendicular to said faces.

2. The multioscillator ring laser gyro as claimed in claim 1, wherein the laser gyro comprises, at least, a laser diode producing the population inversion of the amplifying medium, said diode emitting a light beam passing through the crystal, the beam being linearly polarized along a direction defined by the bisector of the angle made by the directions of the polarization states of the laser cavity eigenmodes.

3. The multioscillator ring laser gyro as claimed in claim 1, wherein the laser gyro comprises, at least, two laser diodes producing the population inversion of the amplifying medium, each emitting a light beam, the first beam passing through the amplifying medium in a direction opposite that of the second beam, each beam being linearly polarized along one of the intrinsic axes of the laser cavity, the polarization direction of the first beam being perpendicular to the polarization direction of the second beam.

4. The multioscillator ring laser gyro as claimed in claim 1, wherein the laser gyro includes a feedback device for controlling the intensity of the counter-propagating modes, comprising at least:
a first optical assembly consisting of a first optical rotator having a nonreciprocal effect and an optical element, said optical element being either an optical rotator having a reciprocal effect or a birefringent element, at least one of the effects or the birefringence being adjustable;
a second optical assembly consisting of a first spatial filtering device and a first optical polarization-splitting element;
a third optical assembly consisting of a second spatial filtering device and a second optical polarization-splitting element, the second optical assembly and the third optical assembly being placed on either side of the first optical assembly, the third optical assembly being placed symmetrically with respect to the second optical assembly;
and in that the ring laser gyro also includes a device for eliminating the blind zone, comprising:
a fourth optical assembly consisting, in succession, of a first quarter-wave plate, a second optical rotator having a nonreciprocal effect and a second quarter-wave plate, the principal axes of which are perpendicular to those of the first quarter-wave plate, the principal axes of the first quarter-wave plate and of the second quarter-wave plate being inclined at about 45° to the linear polarization directions of the four propagation modes, the optical frequencies of the four modes all being different.

5. A system for measuring relative angular positions or angular velocities along three different axes, comprising three multioscillator ring laser gyros as claimed in claim 1, which are oriented along different directions and mounted on a common mechanical structure.
